(19) United States
(12) Patent Application Publication
(10) Pub. No.: US 2026/0158571 A1
(43) Pub. Date: Jun. 11, 2026

(54) GEAR GRINDING METHOD AND GEAR GRINDING DEVICE

(71) Applicant: JTEKT CORPORATION, Kariya-shi (JP)

(72) Inventors: Katsuhito YOSHINAGA, Nara (JP); Hiroaki YOSHIDA, Aichi (JP)

(73) Assignee: JTEKT CORPORATION, Kariya-shi (JP)

(21) Appl. No.: 18/710,397

(22) PCT Filed: Dec. 10, 2021
(86) PCT No.: PCT/JP2021/045442

§ 371 Date: May 15, 2024

(51) Int. Cl. B23F 1/02

(52) U.S. Cl. CPC B23F 1/02

(57) ABSTRACT

A gear grinding method includes a grinding step for grinding a tooth flank of a gear by setting an axis intersection angle between a rotation axis of a workpiece and a rotation axis of a threaded grinding wheel to a composite axis intersection angle obtained by combining a reference axis intersection angle and a correction axis intersection angle. The reference axis intersection angle is an axis intersection angle determined based on a helix angle on a reference circle of the gear and a helix angle on a reference circle of the threaded grinding wheel. The correction axis intersection angle is an axis intersection angle for forming a grinding streak in a direction inclined at a predetermined angle with respect to a tooth trace direction on the tooth flank of the gear by the threaded grinding wheel.

### TECHNICAL FIELD

The present disclosure relates to a gear grinding method and a gear grinding device.

### BACKGROUND ART

Patent Document 1 describes that noise occurs during meshing of gears due to influence of minute steps formed on the tooth flanks of the gears. The minute steps on the tooth flank of the gear are formed, for example, by grinding the tooth flank of the gear with a grinding wheel. Specifically, when the tooth flank of the gear is ground by abrasive grains of the grinding wheel, fine groove-shaped grinding streaks are formed on the tooth flank of the gear in an advancing direction of the abrasive grains at grinding points on the tooth flank. In general, the fine groove-shaped grinding streaks are formed in a direction parallel to a tooth trace direction on the tooth flank of the gear. That is, the steps are formed on the tooth flank of the gear in a tooth depth direction by the plurality of grinding streaks. Patent Document 1 describes that, in order to reduce the steps on the tooth flank, honing or machining with a dressing gear is performed after the tooth flank of the gear is ground with the grinding wheel.

### RELATED ART DOCUMENTS

### Patent Documents

Patent Document 1: Japanese Unexamined Patent Application Publication No. 2000-52145 (JP 2000-52145 A)

### SUMMARY OF THE INVENTION

### Problem to Be Solved by the Invention

In the conventional method, however, additional machining such as honing or machining with the dressing gear is required after the grinding with the grinding wheel in order to reduce the steps on the tooth flank of the gear The additional machining results in an increase in the number of machining steps and an increase in machining costs.

The present disclosure has been made in view of such problems, and provides a gear grinding method and a gear grinding device that can reduce noise due to influence of steps on tooth flanks of gears during meshing of the gears without performing additional machining.

### Means for Solving the Problem

One aspect of the present disclosure is a gear grinding method for grinding a tooth flank of a gear using a threaded grinding wheel. The gear grinding method includes a grinding step for grinding the tooth flank of the gear by setting an axis intersection angle between a rotation axis of a workpiece and a rotation axis of the threaded grinding wheel to a composite axis intersection angle obtained by combining a reference axis intersection angle and a correction axis intersection angle, synchronously rotating the threaded grinding wheel and the workpiece, and relatively moving the threaded grinding wheel in a direction parallel to the rotation axis of the workpiece.

The reference axis intersection angle is an axis intersection angle determined based on a helix angle on a reference circle of the gear and a helix angle on a reference circle of the threaded grinding wheel.

The correction axis intersection angle is an axis intersection angle for forming a grinding streak in a direction inclined at a predetermined angle with respect to a tooth trace direction on the tooth flank of the gear by the threaded grinding wheel.

Another aspect of the present disclosure is a gear grinding device configured to grind a tooth flank of a gear using a threaded grinding wheel. The gear grinding device includes
a grinding processing unit configured to grind the tooth flank of the gear by setting an axis intersection angle between a rotation axis of a workpiece and a rotation axis of the threaded grinding wheel to a composite axis intersection angle obtained by combining a reference axis intersection angle and a correction axis intersection angle, synchronously rotating the threaded grinding wheel and the workpiece, and relatively moving the threaded grinding wheel in a direction parallel to the rotation axis of the workpiece.

The reference axis intersection angle is an axis intersection angle determined based on a helix angle on a reference circle of the gear and a helix angle on a reference circle of the threaded grinding wheel.

The correction axis intersection angle is an axis intersection angle for forming a grinding streak in a direction inclined at a predetermined angle with respect to a tooth trace direction on the tooth flank of the gear by the threaded grinding wheel.

### Effects of the Invention

The axis intersection angle between the rotation axis of the workpiece and the rotation axis of the threaded grinding wheel is set when grinding the tooth flank of the gear using the threaded grinding wheel. The axis intersection angle obtained based on the helix angle on the reference circle of the gear and the helix angle on the reference circle of the threaded grinding wheel is defined as the reference axis intersection angle. For example, when the helix angle on the reference circle of the gear is 0°, the reference axis intersection angle is equal to the helix angle on the reference circle of the threaded grinding wheel. When the helix angle on the reference circle of the gear is not 0°, the reference axis intersection angle is an angle in consideration of the helix angle on the reference circle of the gear with respect to the helix angle on the reference circle of the threaded grinding wheel.

If the axis intersection angle is set to the reference axis intersection angle and the tooth flank of the gear is ground, the grinding streak is formed in a direction parallel to the tooth trace direction on the tooth flank by the threaded grinding wheel on the tooth flank of the gear. In the gear grinding method and the gear grinding device described above, the axis intersection angle between the rotation axis of the workpiece and the rotation axis of the threaded grinding wheel is set to the composite axis intersection angle obtained by combining the reference axis intersection angle and the correction axis intersection angle.

The correction axis intersection angle is the axis intersection angle for forming the grinding streak in the direction inclined at the predetermined angle with respect to the tooth trace direction on the tooth flank of the gear by the threaded grinding wheel. That is, when the axis intersection angle during grinding is set to the composite axis intersection angle obtained by combining the reference axis intersection angle and the correction axis intersection angle, the grinding streak is formed not in the direction parallel to the tooth trace direction but in the direction inclined with respect to the tooth trace direction.

Since the grinding streak can be formed in the direction inclined with respect to the tooth trace direction, for example, the extending direction of the grinding streak can coincide with the meshing progress direction on the tooth flank of the grinding target gear during the meshing of the grinding target gear and the mated gear. When both the directions coincide with each other, the mated gear does not cross over the grinding streak on the tooth flank in the progress of meshing of the gears. Since the grinding streak is not crossed over, the noise that occurs during the meshing of the gears can be reduced.

Even if the extending direction of the grinding streak does not coincide with the meshing progress direction, the crossing over the grinding streak can be reduced when the extending direction of the grinding streak is made closer to the meshing progress direction. As a result, the noise that occurs during the meshing of the gears can be reduced.

As described above, according to the above aspects, it is possible to provide the gear grinding method and the gear grinding device that can reduce the noise due to the influence of the steps on the tooth flanks of the gears during the meshing of the gears without performing additional machining.

The reference numerals in parentheses in the claims indicate correspondence with specific means described in the embodiments to be discussed later, and do not limit the technical scope of the present invention.

### BRIEF DESCRIPTION OF THE DRAWINGS

FIG. 1 is a diagram showing a gear grinding device.

FIG. 2 is a diagram of the gear grinding device of FIG. 1 that is viewed from the left.

FIG. 3(a) is a diagram showing a meshing state of a driving gear and a driven gear, and FIG. 3(b) is a diagram illustrating a meshing line and a meshing progress direction in a case of a helical gear.

FIG. 4 are diagrams illustrating the mechanism of occurrence of meshing noise, in which FIG. 4(a) shows a case where grinding streaks coincide with the meshing progress direction, and FIG. 4(b) shows a case where grinding streaks are inclined with respect to the meshing progress direction.

FIG. 5 is a flowchart showing a process by a grinding condition determination unit that constitutes the gear grinding device in a first embodiment.

FIG. 6 are diagrams illustrating a reference axis intersection angle determination step S3 in FIG. 5, in which FIG. 6(a) shows a state of a threaded grinding wheel and a workpiece, FIG. 6(b) shows the threaded grinding wheel and a grinding target tooth of a gear of the workpiece, and FIG. 6(c) is a diagram of the threaded grinding wheel and the workpiece that are viewed along a rotation axis of the threaded grinding wheel.

FIG. 7 are diagrams illustrating the reference axis intersection angle determination step S3 in FIG. 5, in which FIG. 7(a) is a perspective view showing part of a protruding blade of the threaded grinding wheel and part of the teeth of the gear of the workpiece, FIG. 7(b) is a diagram showing part of grinding streaks on the tooth flank of the workpiece, and FIG. 7(c) is a perspective view showing the grinding streaks on the tooth flank of the gear of the workpiece.

FIG. 8 are diagrams illustrating a correction axis intersection angle determination step S4 in FIG. 5, in which FIG. 8(a) shows a state of the threaded grinding wheel and a workpiece, FIG. 8(b) shows the threaded grinding wheel and a grinding target tooth of a gear of the workpiece, and FIG. 8(c) is a diagram of the threaded grinding wheel and the workpiece that are viewed along the rotation axis of the threaded grinding wheel.

FIG. 9 are diagrams illustrating the correction axis intersection angle determination step S4 in FIG. 5, in which FIG. 9(a) is a perspective view showing part of the protruding blade of the threaded grinding wheel and part of the teeth of the gear of the workpiece, FIG. 9(b) is a diagram showing part of grinding streaks on the tooth flank of the workpiece, and FIG. 9(c) is a perspective view showing the grinding streaks on the tooth flank of the gear of the workpiece.

FIG. 10 is a diagram showing a grinding point on the tooth flank, a velocity vector, and a tooth flank normal component vector on the tooth flank of the gear of the workpiece.

FIG. 11 is a diagram showing a grinding wheel velocity vector, a grinding wheel normal component vector, and a tangent vector on the protruding blade of the threaded grinding wheel.

FIG. 12 is a diagram showing the grinding point on the tooth flank of the gear of the workpiece and a grinding wheel profile point on the threaded grinding wheel in the first embodiment.

FIG. 13 is a diagram showing a grinding point on the tooth flank of a gear of a workpiece and a grinding wheel profile point on a threaded grinding wheel in a reference example.

FIG. 14 is a perspective view showing a meshing progress direction and grinding streaks in a case of a spur gear in a second embodiment.

FIG. 15 is a diagram showing a threaded grinding wheel in a third embodiment.

### MODES FOR CARRYING OUT THE INVENTION

### First Embodiment

### 1. Gear Grinding Device 1

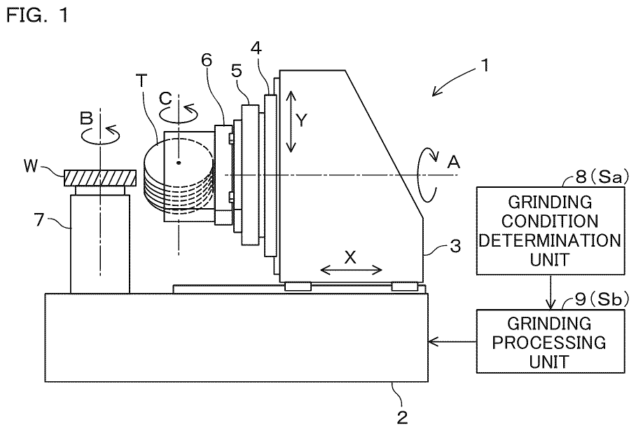

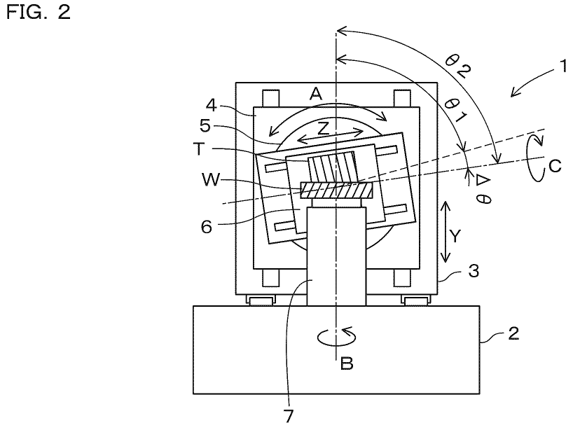

The configuration of a gear grinding device I will be described with reference to FIGS. 1 and 2. The gear grinding device I uses a threaded grinding wheel T to grind the tooth flank of a gear. Specifically, the gear grinding device 1 forms a desired tooth flank of a gear by grinding the tooth flank of a gear-shaped workpiece W using the threaded grinding wheel T.

Specifically, as shown in FIG. 2, the gear grinding device 1 sets an axis intersection angle between a rotation axis B of the workpiece W and a rotation axis C of the threaded grinding wheel T to a composite axis intersection angle θ2. The composite axis intersection angle θ2 is an angle obtained by combining a reference axis intersection angle θ1 and a correction axis intersection angle Δθ. The reference axis intersection angle θ1 and the correction axis intersection angle Δθ will be described later.

The gear grinding device 1 grinds the gear-shaped tooth flank of the workpiece W by relatively moving the threaded grinding wheel T in a direction of a central axis of the workpiece W while the threaded grinding wheel T rotates about the axis C that is a central axis of the threaded grinding wheel T and the workpiece W rotates about the axis B that is the central axis of the workpiece W.

The gear grinding device I is configured to be able to move the workpiece W and the threaded grinding wheel T relative to each other in directions of three orthogonal axes. Further, in the gear grinding device 1, the workpiece W is provided to be rotatable about the axis B, the threaded grinding wheel T is provided to be rotatable about the axis C, and the workpiece W or the threaded grinding wheel T is provided to be rotatable in order to change a relative posture between the workpiece W and the threaded grinding wheel T.

For example, a six-axis processing machine, that is, a processing machine having three linear axes and three rotation axes is applied to the gear grinding device 1. In the present embodiment, in the gear grinding device 1, the workpiece W is rotatable about the axis B, the threaded grinding wheel T is rotatable about an axis A and the axis C, and the threaded grinding wheel T is movable in an X-axis direction, a Y-axis direction, and a Z-axis direction. The axis A is an axis in a direction orthogonal to the rotation axis B of the workpiece W and the rotation axis C of the threaded grinding wheel T. The axis B coincides with the central axis of the workpiece W. The axis C coincides with the central axis of the threaded grinding wheel T. The mechanical configuration of the gear grinding device 1 is not limited to the above, and various configurations can be applied. For example, a horizontal machining center or a vertical machining center having another configuration may be applied to the gear grinding device 1.

The gear grinding device 1 includes, for example, a bed 2, a column 3, a Y-axis slide 4, a rotary member 5, a grinding wheel support member 6, the threaded grinding wheel T, a workpiece support member 7, a grinding condition determination unit 8, and a grinding processing unit 9. The bed 2 is installed on an installation surface. The column 3 is provided to be movable in the X-axis direction (horizontal direction in FIG. 1) with respect to the bed 2 while being guided by an X-axis guide provided on the upper surface of the bed 2. Although illustration is omitted, the column 3 is driven by a ball screw mechanism, a linear motor, etc.

The Y-axis slide 4 is provided to be movable in the Y-axis direction (vertical direction in FIG. 1) with respect to the column 3 while being guided by a Y-axis guide provided on the side surface of the column 3 that extends in the vertical direction. The rotary member 5 is provided on the Y-axis slide 4 and is provided to be rotatable about the axis A that is a horizontal axis. The rotary member 5 is provided to be rotatable within a range of, for example, 360°.

The grinding wheel support member 6 is provided to be movable in the Z-axis direction while being guided by a Z-axis guide provided on the rotary member 5. The Z-axis direction changes as the rotary member 5 rotates about the axis A. The Z-axis direction in the initial state is, for example, the horizontal direction and is a direction orthogonal to the X-axis direction and the Y-axis direction.

The grinding wheel support member 6 supports the threaded grinding wheel T so that it is rotatable about the axis C. The axis C is an axis that coincides with the central axis of the threaded grinding wheel T and is parallel to the Z-axis direction. The threaded grinding wheel T has a helical protruding blade that protrudes radially outward. The threaded grinding wheel T may have a single thread or multiple threads. In the case of multiple threads, the threaded grinding wheel T has a plurality of helical protruding blades. The workpiece support member 7 is provided on the bed 2 and supports the workpiece W so that it is rotatable about the axis B.

The grinding condition determination unit 8 includes at least a processor (arithmetic processing unit). The grinding condition determination unit 8 determines grinding conditions including a protruding blade profile of the threaded grinding wheel T and the composite axis intersection angle θ2 (grinding condition determination step Sa). The composite axis intersection angle θ2 is an angle obtained by combining the reference axis intersection angle θ1 and the correction axis intersection angle Δθ. A method for determining the grinding conditions will be described later.

The grinding processing unit 9 includes at least a processor (arithmetic processing unit). The grinding processing unit 9 performs a process of grinding the tooth flank of the gear of the workpiece W using the threaded grinding wheel T based on the determined grinding conditions (grinding step Sb). The method for grinding the tooth flank of the gear on the workpiece W by the grinding processing unit 9 of the gear grinding device 1 is performed as follows. In the present embodiment, the rotary member 5 is rotated by a predetermined angle about the axis A to achieve a grinding posture in which the axis intersection angle between the rotation axis B of the workpiece W and the rotation axis C of the threaded grinding wheel T is θ2. Next, the grinding processing unit 9 causes the workpiece W and the threaded grinding wheel T to rotate synchronously. Specifically, the workpiece W is rotated about the axis B, the threaded grinding wheel T is rotated about the axis C, and both the rotations are synchronized.

Next, the column 3 is moved in the X-axis direction, the Y-axis slide 4 is moved in the Y-axis direction, and the grinding wheel support member 6 is moved in the Z-axis direction to move the threaded grinding wheel T to an initial grinding position. Next, the threaded grinding wheel T is moved in the direction of the central axis of the workpiece W (direction parallel to the rotation axis B) by moving the Y-axis slide 4 to grind the tooth flank of the gear on the workpiece W.

In the present embodiment, a gear grinding method by the gear grinding device 1 is a process in which the grinding condition determination unit 8 performs processing (grinding condition determination step Sa) and then the grinding processing unit 9 performs processing (grinding step Sb).

### 2. Gear Meshing Progress Direction D_La

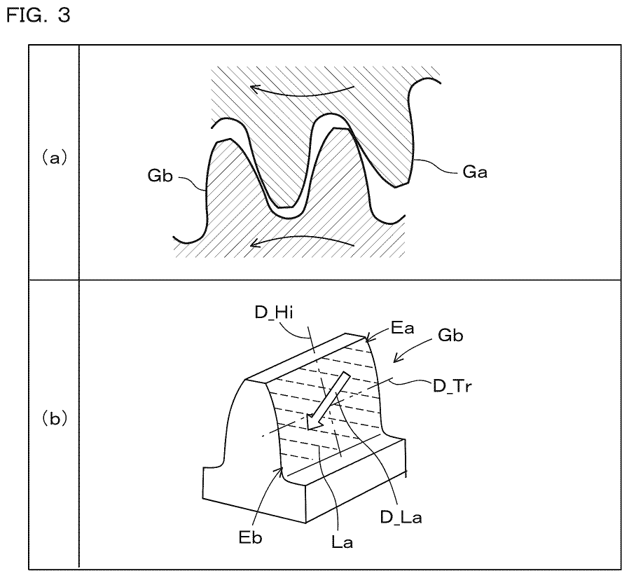

A meshing progress direction D_La will be described with reference to FIG. 3. As shown in FIG. 3(a), a driving gear Ga and a driven gear Gb mesh with each other. The driving gear Ga and the driven gear Gb are gears each having a helix angle.

In this case, as shown by dashed lines in FIG. 3(b), a contact line (meshing line) La with the driving gear Ga on the tooth flank of the driven gear Gb is inclined with respect to a tooth trace direction D_Tr and a tooth depth direction D_Hi. Specifically, a tooth flank corner Ea that is a tooth tip on the tooth flank of the driven gear Gb and is one end in the tooth trace direction D_Tr meshes first, and the contact line (meshing line) La moves toward a tooth flank corner Eb that is a dedendum and is the other end in the tooth trace direction D Tr.

### 3. Mechanism of Occurrence of Meshing Noise and Suppression Method

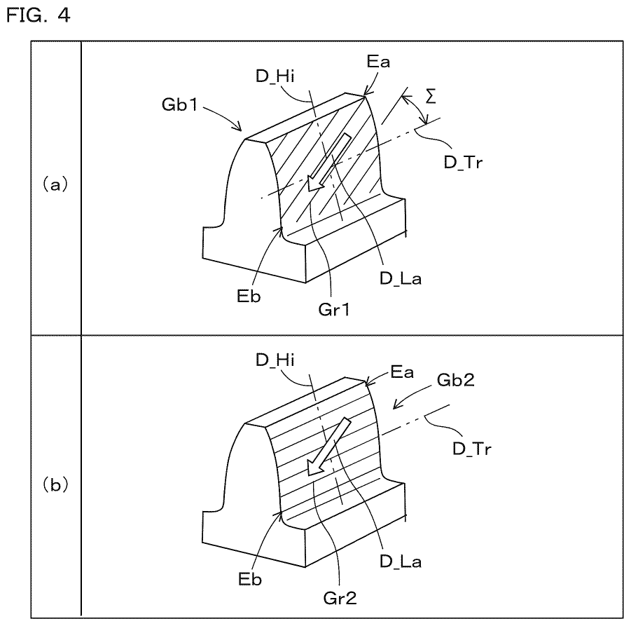

A mechanism of occurrence of meshing noise and a suppression method will be described with reference to FIG. 4. Noise that occurs during meshing of the driving gear Ga and the driven gear Gb is affected by steps formed on the tooth flank of the driving gear Ga and the tooth flank of the driven gear Gb. The tooth flank of the driven gear Gb will be described.

FIG. 4(a) shows a case where grinding streaks Gr1 formed on the tooth flank of a driven gear Gb1 extend in an oblique direction with respect to the tooth trace direction D_Tr and the tooth depth direction D_Hi. FIG. 4(b) shows a case where grinding streaks Gr2 formed on the tooth flank of a driven gear Gb2 extend in a direction parallel to the tooth trace direction D_Tr.

The grinding streaks Gr1, Gr2 are minute grooves formed by grinding the tooth flanks of the driven gears Gb1, Gb2 using the threaded grinding wheel T shown in FIG. 1. The extending directions of the grinding streaks Gr1, Gr2 coincide with directions in which contact abrasive grains in contact with the tooth flanks of the driven gears Gb1, Gb2 among abrasive grains that constitute the threaded grinding wheel T advance.

On the tooth flank of the driven gear Gb1 shown in FIG. 4(a), the contact abrasive grains of the threaded grinding wheel T advance in an oblique direction with respect to the tooth trace direction D_Tr and the tooth depth direction D_Hi. In particular, in the driven gear Gb1, the extending direction of the grinding streak Gr1 coincides with the meshing progress direction D_La. The grinding streak Gr1 is formed in a direction inclined at a predetermined angle Σ with respect to the tooth trace direction D_Tr. In detail, the grinding streak Gr1 is not formed into a straight line but into an arc with a large number of minute angles. Therefore, the predetermined angle Σ has an angular range.

On the tooth flank of the driven gear Gb2 shown in FIG. 4(b), the contact abrasive grains of the threaded grinding wheel T advance in a direction parallel to the tooth trace direction D_Tr. Therefore, in the driven gear Gb2, the extending direction of the grinding streak Gr2 does not coincide with the meshing progress direction D_La.

In the driven gear Gb1 shown in FIG. 4(a), the meshing point does not cross over the grinding streak Gr1 in the process of meshing with the driving gear Ga. Therefore, noise due to the meshing point crossing over the grinding streak Gr1 does not occur. In the driven gear Gb2 shown in FIG. 4(b), the meshing point crosses over the grinding streak Gr2 in the process of meshing with the driving gear Ga. Therefore, noise due to the meshing point crossing over the grinding streak Gr2 occurs.

By setting the extending direction of the grinding streak Gr1 to coincide with the meshing progress direction D_La in this way as shown in FIG. 4(a), the occurrence of noise due to the crossing over the grinding streak Gr1 (meshing noise) can be suppressed. Even if the extending direction of the grinding streak Gr1 does not completely coincide with the meshing progress direction D_La, the occurrence of meshing noise can be suppressed as the extending direction of the grinding streak Gr1 approaches the meshing progress direction D_La. Therefore, even if the extending direction of the grinding streak Gr1 does not completely coincide with the meshing progress direction D_La, the approach of the extending direction of the grinding streak Gr1 to the meshing progress direction D_La effectively works on the reduction in the meshing noise.

### 4. Processing by Grinding Condition Determination Unit 8

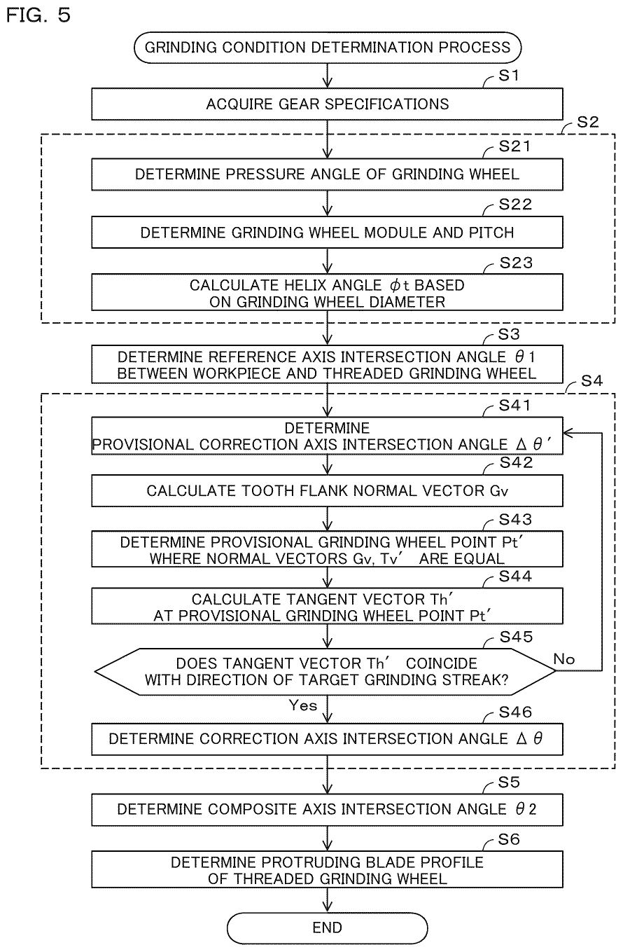

The processing by the grinding condition determination unit 8 (grinding condition determination step Sa) will be described with reference to FIGS. 5 to 12. As described above, the grinding condition determination unit 8 determines the grinding conditions including the protruding blade profile of the threaded grinding wheel T and the axis intersection angle θ2. In particular, the grinding condition determination unit 8 determines the grinding conditions under which the extending direction of the grinding streak Gr1 can coincide with a target direction as shown in FIG. 4(a).

The grinding condition determination unit 8 performs a gear specification acquisition step S1, a threaded grinding wheel specification determination step S2, a reference axis intersection angle determination step S3, a correction axis intersection angle determination step S4, a composite axis intersection angle determination step S5, and a protruding blade profile determination step S6.

The grinding condition determination unit 8 first acquires the specifications of the grinding target gear Gb (SI). The specifications of the gear Gb include a module, a normal pressure angle, a helix angle φw on a reference circle, the number of teeth, a profile shift coefficient, a reference pitch diameter, a base diameter, a tip diameter, a root diameter, etc.

Next, the grinding condition determination unit 8 determines the specifications of the threaded grinding wheel T (S2). The specifications of the threaded grinding wheel T are determined as follows. The grinding condition determination unit 8 determines a pressure angle of the threaded grinding wheel T based on the acquired specifications of the gear Gb (S21). Next, the grinding condition determination unit 8 determines a grinding wheel module and a pitch (S22). Next, the grinding condition determination unit 8 calculates a helix angle φt on a reference circle corresponding to a grinding wheel diameter (S23).

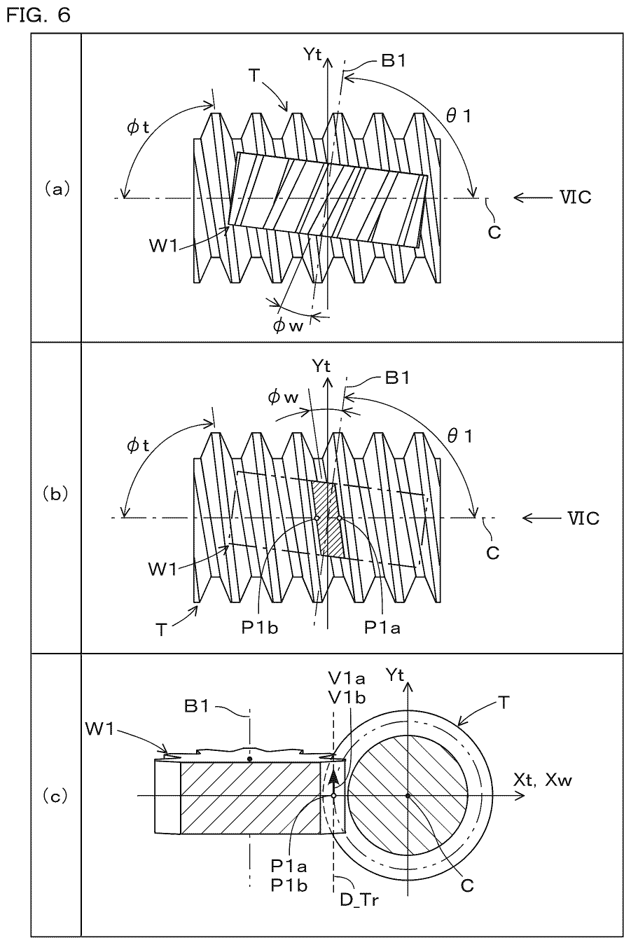

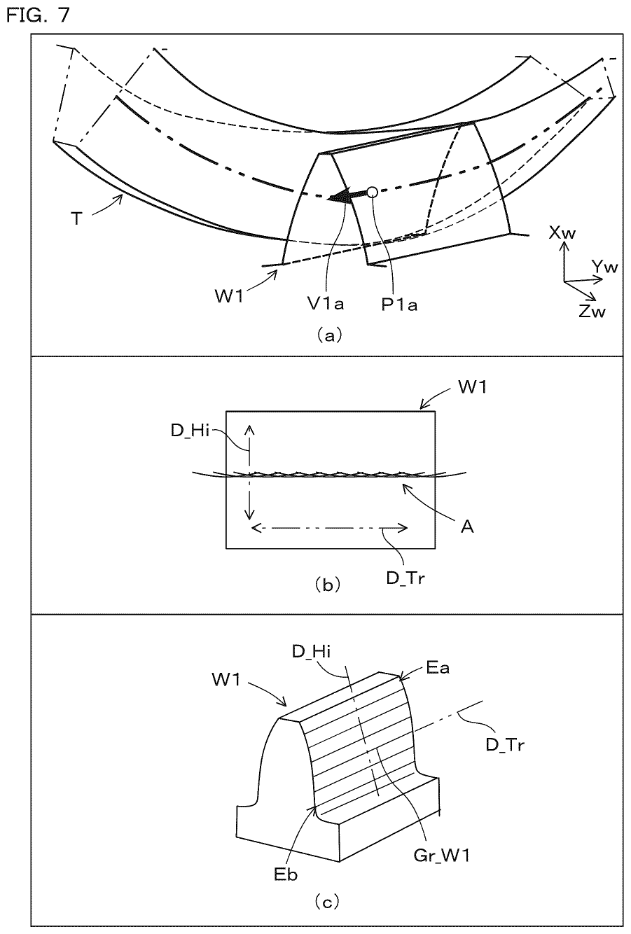

Next, the reference axis intersection angle θ1 is determined (S3). The reference axis intersection angle θ1 will be described with reference to FIGS. 6 and 7. The determination of the reference axis intersection angle θ1 will be described under the assumption that the workpiece is W1 and the rotation axis of the workpiece W is B1. The workpiece W1 and the rotation axis B1 are used separately from a workpiece W2 and a rotation axis B2 in the determination of the correction axis intersection angle Δθ described later.

FIG. 6(a) and 6(b) are diagrams that are viewed in a direction orthogonal to the rotation axis B1 of the workpiece W1 and orthogonal to the rotation axis C of the threaded grinding wheel T. As shown in FIGS. 6(a) and 6(b), the reference axis intersection angle θ1 is an axis intersection angle between the rotation axis B1 of the workpiece W1 and the rotation axis C of the threaded grinding wheel T. The reference axis intersection angle θ1 is an axis intersection angle determined based on the helix angle φw on the reference circle of the gear of the workpiece W1 and the helix angle φt on the reference circle of the threaded grinding wheel T. Specifically, the reference axis intersection angle θ1 is an axis intersection angle between the rotation axis B1 of the workpiece W1 and the rotation axis C of the threaded grinding wheel T in a state in which the tooth trace direction D_Tr of a portion of the workpiece W1 to be ground coincides with a blade trace direction on the reference circle of the grinding protruding blade of the threaded grinding wheel T.

If the tooth flanks of the gear of the workpiece W1 are ground by the threaded grinding wheel T with the reference axis intersection angle θ1 set, a grinding point P1a on one tooth flank and a grinding point P1b on the other tooth flank of the workpiece W1 are ground by the threaded grinding wheel T as shown in FIG. 6(b) and 6(c). When projected in a direction shown in FIG. 6(b), the grinding points P1a, P1b are located on the rotation axis C of the threaded grinding wheel T. When projected in a direction shown in FIG. 6(c), the grinding points P1a, P1b are located on Xt, Xw.

As shown in FIG. 6(c), at the grinding points P1a, P1b, the threaded grinding wheel T rotates about the axis C, and therefore the abrasive grains of the protruding blade of the threaded grinding wheel T rotate about the axis C. Therefore, at the grinding points P1a, P1b, the abrasive grains of the protruding blade of the threaded grinding wheel T move directly upward in FIG. 6(c).

Moving direction vectors of the abrasive grains of the protruding blade of the threaded grinding wheel T at the grinding points P1a, P1b are represented by V1a, V1b, respectively. When viewed in the axial direction of the threaded grinding wheel T (projected in the axial direction of the threaded grinding wheel T) as shown in FIG. 6(c), the tooth trace direction D_Tr of the gear of the workpiece W2 coincides with velocity vectors of the rotation of the threaded grinding wheel T at the grinding points P1a, P1b on the protruding blade of the threaded grinding wheel T (components of V1a, V1b on the drawing sheet of FIG. 6(c)). In other words, when projected onto a working plane representing the tooth flank of the workpiece W1, the component in the tooth trace direction D_Tr of the gear of the workpiece W1 on the working plane coincides with the components of the velocity vectors of the rotation of the threaded grinding wheel T at the grinding points P1a, P1b on the working plane.

The enlarged view of FIG. 7(a) shows the moving direction vector V1a of the abrasive grains of the protruding blade of the threaded grinding wheel T at the grinding point P1a on one tooth flank of the workpiece W1. As shown in FIG. 7(b) and 7(c), a grinding streak Gr_W1 is formed by the abrasive grains of the protruding blade of the threaded grinding wheel T on one tooth flank of the workpiece W1. That is, the grinding streak Gr_W1 is formed substantially parallel to the tooth trace direction D_Tr on the tooth flank of the workpiece W1. In detail, the grinding streak Gr_W1 is not formed into a straight line but into an arc with a large number of minute angles, but is substantially parallel to the tooth trace direction D_Tr as a whole. Therefore, it can be said that the reference axis intersection angle θ1 is an axis intersection angle for forming the grinding streak Gr_W1 in a direction parallel to the tooth trace direction D_Tr on the tooth flank of the gear of the workpiece WI by the threaded grinding wheel T.

The description will be given referring back to FIG. 5. When the reference axis intersection angle θ1 is determined (S3), the correction axis intersection angle Δθ is then determined (S4). As shown in FIG. 4(a), the correction axis intersection angle Δθ is an axis intersection angle for forming the grinding streak Gr1 in a direction inclined at the predetermined angle Σ with respect to the tooth trace direction D_Tr on the tooth flank of the gear of the workpiece W by the threaded grinding wheel T.

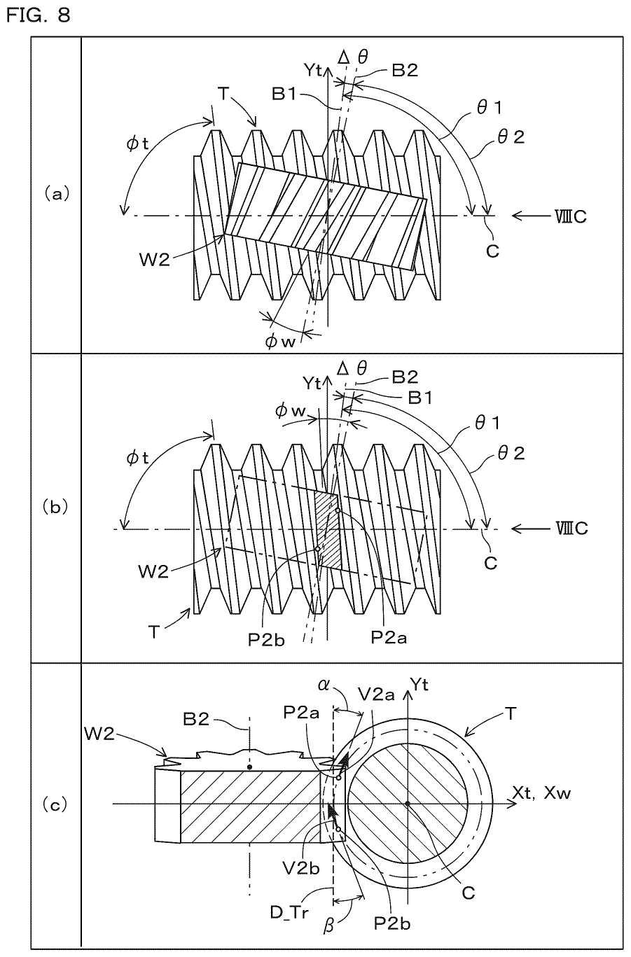

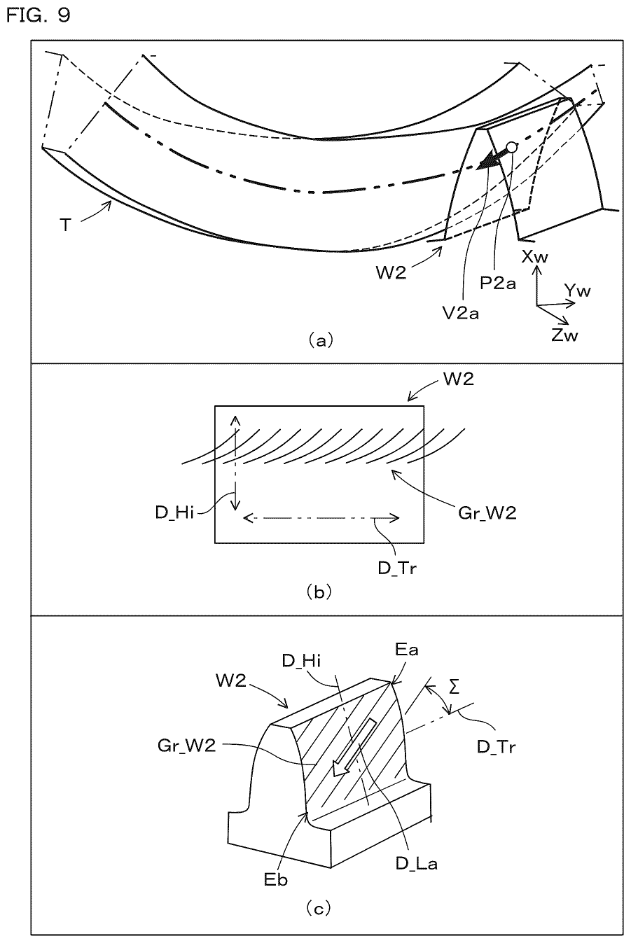

The correction axis intersection angle Δθ will be described with reference to FIGS. 8 and 9. As shown in FIG. 8(a) and 8(b), the correction axis intersection angle Δθ is an axis intersection angle additionally provided to the reference axis intersection angle θ1. That is, when the correction axis intersection angle Δθ is additionally provided, the axis intersection angle between the rotation axis B2 of the workpiece W2 and the rotation axis C of the threaded grinding wheel T is the composite axis intersection angle θ2 obtained by combining the reference axis intersection angle θ1 and the correction axis intersection angle Δθ. The correction axis intersection angle Δθ may be a positive value or a negative value.

When the tooth flanks of the gear of the workpiece W2 are ground by the threaded grinding wheel T with the angle set to the composite axis intersection angle θ2 obtained by adding the correction axis intersection angle Δθ to the reference axis intersection angle θ1, a grinding point P2a on one tooth flank and a grinding point P2b on the other tooth flank of the workpiece W2 are ground by the threaded grinding wheel T as shown in FIG. 8(b) and 8(c). When projected in a direction shown in FIG. 8(b), the grinding point P2a is located above the rotation axis C of the threaded grinding wheel T, and the grinding point P2b is located below the rotation axis C of the threaded grinding wheel T. When projected in a direction shown in FIG. 8(c), the grinding point P2a is located above Xt, Xw, and the grinding point P2b is located below Xt, Xw.

As shown in FIG. 8(c), at the grinding points P2a, P2b, the threaded grinding wheel T rotates about the axis C, and therefore the abrasive grains of the protruding blade of the threaded grinding wheel T rotate about the axis C. Therefore, at the grinding point P2a, the abrasive grains of the protruding blade of the threaded grinding wheel T move toward the upper right in FIG. 8(c). At the grinding point P2b, the abrasive grains of the protruding blade of the threaded grinding wheel T move toward the upper left in FIG. 8(c).

Moving direction vectors of the abrasive grains of the protruding blade of the threaded grinding wheel T at the grinding points P2a, P2b are represented by V2a, V2b, respectively. When viewed in the axial direction of the threaded grinding wheel T (projected in the axial direction of the threaded grinding wheel T) as shown in FIG. 8(c), the tooth trace direction D_Tr of the gear of the workpiece W2 and velocity vectors of the rotation of the threaded grinding wheel T at the grinding points P2a, P2b on the protruding blade of the threaded grinding wheel T (components of V2a, V2b on the drawing sheet of FIG. 8(c)) have angles a, B. In other words, when projected onto a working plane representing the tooth flank of the workpiece W2, the component in the tooth trace direction D_Tr of the gear of the workpiece W2 on the working plane and the components of the velocity vectors of the rotation of the threaded grinding wheel T at the grinding points P2a, P2b on the working plane have angles.

The enlarged view of FIG. 9(a) shows the moving direction vector V2a of the abrasive grains of the protruding blade of the threaded grinding wheel T at the grinding point P2a on one tooth flank of the workpiece W2. As shown in FIG. 9(b) and 9(c), a grinding streak Gr_W2 is formed by the abrasive grains of the protruding blade of the threaded grinding wheel T on one tooth flank of the workpiece W2. That is, the grinding streak Gr_W2 is formed in a direction inclined at the predetermined angle Σ with respect to the tooth trace direction D_Tr on the tooth flank of the workpiece W2. In detail, the grinding streak Gr_W2 is not formed into a straight line but into an arc with a large number of minute angles, but is formed in the direction inclined at the predetermined angle Σ with respect to the tooth trace direction D_Tr as a whole. Therefore, it can be said that the correction axis intersection angle Δθ is an axis intersection angle for forming the grinding streak Gr_W2 in the direction inclined at the predetermined angle E with respect to the tooth trace direction D_Tr on the tooth flank of the gear of the workpiece W2 by the threaded grinding wheel T.

As shown in FIG. 9(c), the grinding streak Gr_W2 on one tooth flank of the gear of the workpiece W2 is formed in a direction inclined at a positive predetermined angle Σ with respect to the tooth trace direction D_Tr. Although illustration is omitted, the grinding streak Gr_W2 on the other tooth flank of the gear of the workpiece W2 is formed in a direction inclined at a negative predetermined angle (−Σ) with respect to the tooth trace direction D_Tr.

A method for determining the correction axis intersection angle Δθ, that is, details of the correction axis intersection angle determination step S4 will be described with reference to FIGS. 5 and 10 to 12. First, as shown in FIG. 5, a provisional correction axis intersection angle Δθ′ is determined (S41), The provisional correction axis intersection angle Δθ′ determined first is any value and serves as an initial value for determining the correction axis intersection angle Δθ.

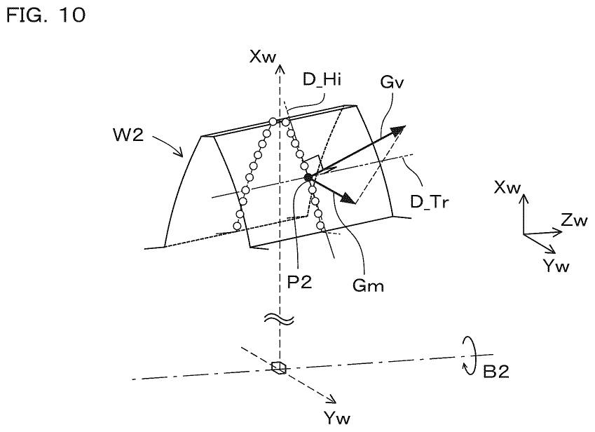

Then, as shown in FIGS. 5 and 10, a normal component vector Gv on the tooth flank (referred to as a tooth flank normal component vector) in a velocity vector Gm at the grinding point P2 on the tooth flank of the gear of the workpiece W2 is calculated when the workpiece W2 is rotated about the axis B2 (S42). The grinding point P2 is set as a plurality of discrete points in a cross section orthogonal to the tooth trace direction D_Tr on the tooth flank of the workpiece W2. The plurality of grinding points P2 is points represented by outline circles and solid circles in FIG. 10. In FIG. 10, the velocity vector Gm and the normal component vector Gv are the ones at the grinding point P2 represented by the solid circle.

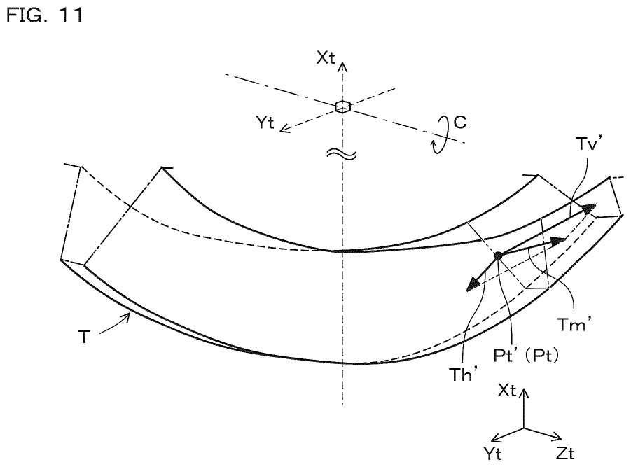

Next, the provisional correction axis intersection angle Δθ′ is provided as the correction axis intersection angle Δθ. That is, a provisional composite axis intersection angle θ2′ is set by adding the provisional correction axis intersection angle Δθ′ to the reference axis intersection angle θ1. As shown in FIG. 11, Tm′ represents a velocity vector at a point Pt′ on the protruding blade of the threaded grinding wheel T (referred to as a grinding wheel velocity vector) when the threaded grinding wheel T is moved relative to the workpiece W2. The tooth flank normal component vector Gv at the grinding point P2 on the tooth flank of the workpiece W2 shown in FIG. 10 and a component Tv′ (referred to as a grinding wheel normal component vector) in the direction of the tooth flank normal component vector Gv in the grinding wheel velocity vector Tm′ at the point Pt′ on the threaded grinding wheel T shown in FIG. 11 are calculated. That is, the direction of the tooth flank normal component vector Gv on the workpiece W2 coincides with the direction of the grinding wheel normal component vector Tv′ on the threaded grinding wheel T. Then, the point Pt′ on the protruding blade of the threaded grinding wheel T when the magnitude of the tooth flank normal component vector Gv on the workpiece W2 is equal to the magnitude of the grinding wheel normal component vector Tv′ on the threaded grinding wheel T is determined. The determined point Pt′ on the protruding blade is set as a provisional grinding wheel point Pt′ (S43).

Next, a tangent vector Th′ on the protruding blade of the threaded grinding wheel T is calculated as shown in FIGS. 5 and 11 (S44). Specifically, when the provisional grinding wheel point Pt′ is determined in S43, a normal plane profile of the protruding blade of the threaded grinding wheel T is determined as shown by the long dashed double-short dashed line in FIG. 11. Then, the tangent vector Th′ that is a vector in a direction orthogonal to the normal plane of the protruding blade in the grinding wheel velocity vector Tm′ at the provisional grinding wheel point Pt′ on the protruding blade of the threaded grinding wheel T is calculated. The tangent vector Th′ corresponds to the moving direction vector V2a of the abrasive grains of the protruding blade of the threaded grinding wheel T shown in FIG. 9(a).

Next, determination is made as to whether the tangent vector Th′ on the threaded grinding wheel T at a predetermined grinding point P2 (e.g., the center point of the tooth depth) on the tooth flank of the workpiece W2 coincides with the direction of the preset target grinding streak Gr_W2 (S45). When compared with the angle in the meshing progress direction at this time, the tangent vector Th′ is projected onto the working plane representing the tooth flank of the workpiece W2 and compared with the angle on the working plane.

When determination is made that the tangent vector Th′ coincides with the direction of the target grinding streak Gr_W2 (S45: Yes), the provisional grinding wheel point Pt′ is determined as a grinding wheel profile point Pt, and the provisional correction axis intersection angle Δθ′ when the tangent vector Th′ coincides is determined as the correction axis intersection angle Δθ (S46). When determination is made that the tangent vector Th′ does not coincide with the direction of the target grinding streak Gr_W2 (S45: No), the process returns to S41 to determine a new provisional correction axis intersection angle Δθ′, and the processes from S42 onward are performed.

That is, the provisional correction axis intersection angle Δθ′ at which the tangent vector Th′ on the threaded grinding wheel T at the predetermined grinding point P2 (e.g., the center point of the tooth depth) on the tooth flank of the workpiece W2 coincides with the direction of the target grinding streak Gr_W2 is found in the correction axis intersection angle determination step S4. In the process of the correction axis intersection angle determination step S4, the same process is performed on the plurality of grinding points P2 on the tooth flank of the workpiece W2 as shown in FIG. 10, thereby determining the grinding wheel profile points Pt corresponding to all the grinding points P2.

Next, as shown in FIG. 5, the composite axis intersection angle θ2 is determined by combining the reference axis intersection angle θ1 determined in S3 and the correction axis intersection angle Δθ determined in S4 (S5).

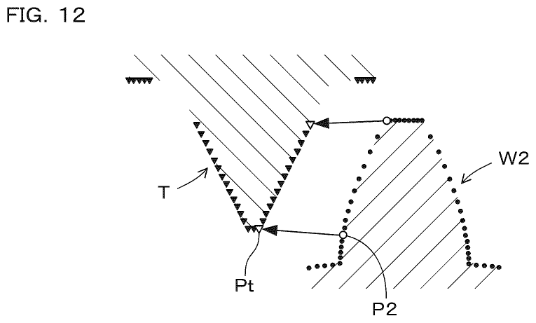

Next, as shown in FIG. 5, the protruding blade profile of the threaded grinding wheel T is determined based on the plurality of grinding wheel profile points Pt in the state in which the axis intersection angle between the rotation axis B2 of the workpiece W2 and the rotation axis C of the threaded grinding wheel T is the composite axis intersection angle θ2 (S6). Specifically, as shown in FIG. 12, the sectional shape of the protruding blade of the threaded grinding wheel T is determined based on the grinding wheel profile points Pt corresponding to the grinding points P2 on the tooth flank of the gear of the workpiece W2.

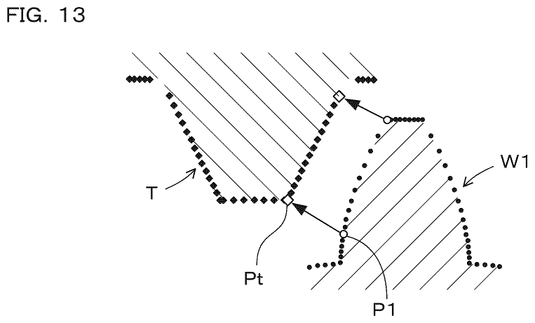

If the correction axis intersection angle Δθ is zero, that is, the axis intersection angle between the rotation axis B1 of the workpiece W1 and the rotation axis C of the threaded grinding wheel T is the reference axis intersection angle θ1 as shown in FIGS. 6 and 7, the sectional shape of the protruding blade of the threaded grinding wheel T is a shape shown in FIG. 13. That is, the grinding wheel profile points Pt corresponding to the grinding points P1 on the tooth flank of the gear of the workpiece W1 are determined, and the sectional shape of the protruding blade of the threaded grinding wheel T is determined based on the grinding wheel profile points Pt.

It is understood that the sectional shape of the protruding blade of the threaded grinding wheel T in consideration of the correction axis intersection angle Δθ in FIG. 12 has a smaller width (width in the lateral direction in FIGS. 12 and 13) and a larger protrusion amount (height in the vertical direction in FIGS. 12 and 13) than the sectional shape of the protruding blade of the threaded grinding wheel T without consideration of the correction axis intersection angle Δθ in FIG. 13.

As described above, the grinding condition determination unit 8 determines the reference axis intersection angle θ1 and the correction axis intersection angle Δθ, and combines the determined reference axis intersection angle θ1 and the determined correction axis intersection angle Δθ, thereby determining the composite axis intersection angle θ2 as one of the grinding conditions. Further, the grinding condition determination unit 8 determines the protruding blade profile of the threaded grinding wheel T as one of the grinding conditions. The determined protruding blade of the threaded grinding wheel T is configured to be able to simultaneously grind both the tooth flanks of the gear of the workpiece W2.

### 5. Processing by Grinding Processing Unit 9

The processing by the grinding processing unit 9 (grinding step Sb) will be described. The grinding processing unit 9 applies the grinding conditions determined by the grinding condition determination unit 8 to grind the tooth flanks of the gear of the workpiece W with the threaded grinding wheel T.

The grinding processing unit 9 positions the workpiece W2 that is a helical gear and the threaded grinding wheel T as shown in FIG. 8(a), 8(b), and 8(c). The axis intersection angle between the rotation axis B2 of the workpiece W2 and the rotation axis C of the threaded grinding wheel T is set to the composite axis intersection angle θ2. Then, the workpiece W2 and the threaded grinding wheel T are rotated synchronously, and the threaded grinding wheel T is relatively moved in a direction parallel to the rotation axis B2 of the workpiece W2.

Then, both the tooth flanks of the gear of the workpiece W2 are simultaneously ground by the threaded grinding wheel T as shown in FIG. 8(b). As shown in FIG. 9(b) and 9(c), the grinding streaks Gr W2 are formed by the threaded grinding wheel T on the ground tooth flanks of the workpiece W2. The grinding streaks Gr_W2 are formed in a direction inclined at the predetermined angle Σ with respect to the tooth trace direction D_Tr. In particular, the extending direction of the formed grinding streak Gr_W2 coincides with the meshing progress direction D La on the tooth flank of the workpiece W2. That is, the predetermined angle Σ is set to the angle formed by the tooth trace direction D_Tr on the tooth flank of the driven gear Gb (shown in FIG. 3) as the workpiece W2 and the meshing progress direction D La of the driving gear Ga that is a mated gear. Thus, the meshing noise can be reduced.

### 6. Effects

According to the present embodiment, the axis intersection angle between the rotation axis B2 of the workpiece W2 and the rotation axis C of the threaded grinding wheel T is set when grinding the tooth flank of the gear of the workpiece W2 with the threaded grinding wheel T. The axis intersection angle obtained based on the helix angle φw on the reference circle of the gear of the workpiece W2 and the helix angle φt on the reference circle of the threaded grinding wheel T is defined as the reference axis intersection angle θ1. In the present embodiment, the gear of the workpiece W2 is the helical gear. Therefore, the helix angle φw on the reference circle of the gear of the workpiece W2 is not 0°. In this case, the reference axis intersection angle θ1 is an angle in consideration of the helix angle φw on the reference circle of the gear of the workpiece W2 with respect to the helix angle φt on the reference circle of the threaded grinding wheel T.

If the axis intersection angle is set to the reference axis intersection angle θ1 and the tooth flank of the gear of the workpiece WI is ground as shown in FIGS. 6 and 7, the grinding streak Gr W1 is formed in a direction parallel to the tooth trace direction D Tr on the tooth flank by the threaded grinding wheel T on the tooth flank of the gear of the workpiece W1. In the present embodiment, the axis intersection angle between the rotation axis B2 of the workpiece W2 and the rotation axis C of the threaded grinding wheel T is set to the composite axis intersection angle θ2 obtained by combining the reference axis intersection angle θ1 and the correction axis intersection angle Δθ as shown in FIGS. 8 and 9.

The correction axis intersection angle Δθ is the axis intersection angle for forming the grinding streak Gr_W2 in the direction inclined at the predetermined angle Σ with respect to the tooth trace direction D_Tr on the tooth flank of the gear of the workpiece W2 by the threaded grinding wheel T. That is, when the axis intersection angle during grinding is set to the composite axis intersection angle θ2 obtained by combining the reference axis intersection angle θ1 and the correction axis intersection angle Δθ, the grinding streak Gr_W2 is formed not in the direction parallel to the tooth trace direction D_Tr but in the direction inclined with respect to the tooth trace direction D_Tr.

Since the grinding streak Gr_W2 can be formed in the direction inclined with respect to the tooth trace direction D_Tr, for example, the extending direction of the grinding streak Gr_W2 can coincide with the meshing progress direction D_La on the tooth flank of the grinding target gear during the meshing of the grinding target gear and the mated gear. When both the directions coincide with each other, the mated gear Ga does not cross over the grinding streak Gr_W2 on the tooth flank in the progress of meshing of the gears. Since the grinding streak Gr_W2 is not crossed over, the noise that occurs during the meshing of the gears can be reduced.

Even if the extending direction of the grinding streak Gr_W2 does not coincide with the meshing progress direction D_La, the crossing over the grinding streak Gr_W2 can be reduced when the extending direction of the grinding streak Gr_W2 is made closer to the meshing progress direction D_La. As a result, the noise that occurs during the meshing of the gears can be reduced.

In particular, when the workpiece W2 is a helical gear, the extending direction of the grinding streak Gr_W2 can substantially coincide with the meshing progress direction D_La. Thus, the noise that occurs during the meshing of the helical gears can be reduced.

As described above, it is possible to reduce the noise due to the influence of the steps on the tooth flanks of the gears during the meshing of the gears without performing additional machining.

In the present embodiment, the threaded grinding wheel T is configured to be able to simultaneously grind both the tooth flanks of the gear of the workpiece W2 as shown in FIG. 8. In the grinding step Sb by the grinding processing unit 9, the threaded grinding wheel T simultaneously grinds both the tooth flanks of the gear of the workpiece W2. As shown in FIG. 9, the grinding streak Gr_W2 on one tooth flank of the gear of the workpiece W2 is formed in the direction inclined at the positive predetermined angle Σ with respect to the tooth trace direction D_Tr. The grinding streak Gr_W2 on the other tooth flank of the gear of the workpiece W2 is formed in the direction inclined at the negative predetermined angle (−Σ) with respect to the tooth trace direction D_Tr. When the direction of the grinding streak Gr_W2 satisfies the above condition, both the tooth flanks can be ground simultaneously as described above. Thus, the number of grinding steps can be reduced.

### Second Embodiment

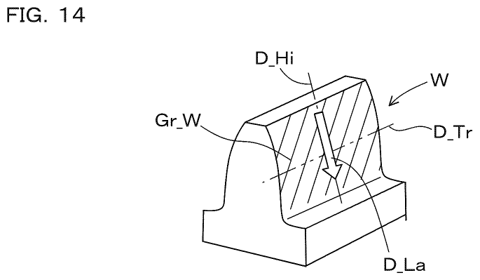

In the first embodiment, the workpiece W has been described as the helical gear having the helix angle φw. In addition, the workpiece W can also be a spur gear as shown in FIG. 14. When the workpiece W is the spur gear, the helix angle on the reference circle is 0°. As shown in FIG. 14, in the workpiece W that is the spur gear, the meshing progress direction D_La of a mated gear coincides with the tooth depth direction D_Hi.

If the extending direction of the grinding streak Gr_W is parallel to the tooth trace direction D_Tr, the meshing point crosses over the grinding streaks Gr_W many times, which causes meshing noise. Therefore, as shown in FIG. 14, the extending direction of the grinding streak Gr_W is at an inclination angle with respect to the tooth trace direction D_Tr and at an inclination angle with respect to the tooth depth direction D_Hi. That is, the extending direction of the grinding streak Gr_W is inclined with respect to the meshing progress direction D_La, but has an angle smaller than the right angle.

As described in the first embodiment, the noise due to the meshing point crossing over the grinding streak Gr_W can be reduced greatly when the extending direction of the grinding streak Gr_W coincides with the meshing progress direction D_La. However, the grinding streak Gr_W cannot be formed in a direction parallel to the tooth depth direction D_Hi. Therefore, the grinding streak Gr_W is set in a direction as close to the meshing progress direction D_La as possible.

### Third Embodiment

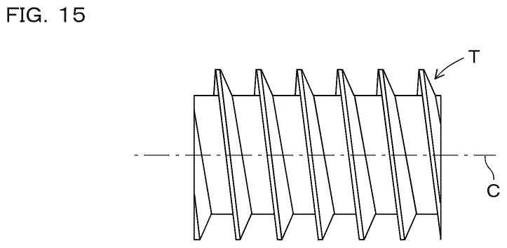

The above embodiments illustrate the example in which both the tooth flanks of the gear of the workpiece W are simultaneously ground by the threaded grinding wheel T. In addition, the threaded grinding wheel T may be configured to grind only one tooth flank of the gear of the workpiece W. The threaded grinding wheel T is formed as shown in FIG. 15. That is, the protruding blade of the threaded grinding wheel T has only one side of the protruding blade of the threaded grinding wheel T that is determined in the first embodiment.

In the first embodiment, when the extending direction of the grinding streak Gr_W2 on one tooth flank is determined by simultaneously grinding both the tooth flanks of the workpiece W, the extending direction of the grinding streak Gr_W2 on the other tooth flank is determined inevitably. To freely set the extending directions of the grinding streaks Gr_W2 on the individual tooth flanks, it is preferable to use the threaded grinding wheel T as shown in FIG. 15. In this case, one tooth flank is ground by the threaded grinding wheel T shown in FIG. 15, and the other tooth flank is ground by an unillustrated threaded grinding wheel.

1. A gear grinding method for grinding a tooth flank of a gear using a threaded grinding wheel, the gear grinding method comprising:
a grinding step for grinding the tooth flank of the gear by setting an axis intersection angle between a rotation axis of a workpiece and a rotation axis of the threaded grinding wheel to a composite axis intersection angle obtained by combining a reference axis intersection angle and a correction axis intersection angle, synchronously rotating the threaded grinding wheel and the workpiece, and relatively moving the threaded grinding wheel in a direction parallel to the rotation axis of the workpiece, wherein
the reference axis intersection angle is an axis intersection angle determined based on a helix angle on a reference circle of the gear and a helix angle on a reference circle of the threaded grinding wheel, and
the correction axis intersection angle is an axis intersection angle for forming a grinding streak in a direction inclined at a predetermined angle with respect to a tooth trace direction on the tooth flank of the gear by the threaded grinding wheel.

2. The gear grinding method according to claim 1, wherein the reference axis intersection angle is an axis intersection angle for forming the grinding streak in a direction parallel to the tooth trace direction on the tooth flank of the gear by the threaded grinding wheel.

3. The gear grinding method according to claim 1, wherein when viewed in an axial direction of the threaded grinding wheel, the tooth trace direction of the gear and a velocity vector of rotation of the threaded grinding wheel at a grinding point on a protruding blade of the threaded grinding wheel have an angle.

4. The gear grinding method according to claim 1, wherein:
the threaded grinding wheel is configured to be able to simultaneously grind both tooth flanks of the gear of the workpiece;
the grinding streak on one of the tooth flanks of the gear is formed in a direction inclined at a positive predetermined angle with respect to the tooth trace direction;
the grinding streak on the other of the tooth flanks of the gear is formed in a direction inclined at a negative predetermined angle with respect to the tooth trace direction; and
the grinding step includes simultaneously grinding both the tooth flanks of the gear of the workpiece by the threaded grinding wheel.

5. The gear grinding method according to claim 1, wherein:
the threaded grinding wheel is configured to be able to grind only one tooth flank of the gear of the workpiece, and
the grinding step includes grinding the only one tooth flank of the gear of the workpiece by the threaded grinding wheel.

6. The gear grinding method according to claim 1, comprising:
a grinding condition determination step for determining grinding conditions including a profile of a protruding blade of the threaded grinding wheel and the composite axis intersection angle; and
the grinding step for grinding the tooth flank of the gear using the threaded grinding wheel based on the determined grinding conditions.

7. The gear grinding method according to claim 6, wherein the grinding condition determination step includes:
a reference axis intersection angle determination step for determining the reference axis intersection angle based on the helix angle on the reference circle of the gear and the helix angle on the reference circle of the threaded grinding wheel;
a correction axis intersection angle determination step for determining the correction axis intersection angle for forming the grinding streak in the direction inclined at the predetermined angle with respect to the tooth trace direction on the tooth flank of the gear of the workpiece by the threaded grinding wheel; and
a protruding blade profile determination step for determining the profile of the protruding blade of the threaded grinding wheel in a state in which the axis intersection angle between the rotation axis of the workpiece and the rotation axis of the threaded grinding wheel is the composite axis intersection angle.

8. The gear grinding method according to claim 7, wherein the correction axis intersection angle determination step includes:
calculating a tooth flank normal component vector that is a normal component vector on the tooth flank in a velocity vector at a grinding point on the tooth flank of the gear when the workpiece is rotated;
setting a provisional correction axis intersection angle as the correction axis intersection angle, calculating a grinding wheel normal component vector that is a component in a direction of the tooth flank normal component vector in a velocity vector at a provisional grinding wheel point on the protruding blade of the threaded grinding wheel when the threaded grinding wheel is moved relative to the workpiece, and determining the provisional grinding wheel point when a magnitude of the tooth flank normal component vector is equal to a magnitude of the grinding wheel normal component vector;
calculating a tangent vector on the protruding blade in a velocity vector at the determined provisional grinding wheel point;
determining whether the tangent vector coincides with a direction of the grinding streak set in advance, determining the provisional grinding wheel point when the tangent vector coincides as a grinding wheel profile point and determining the provisional correction axis intersection angle when the tangent vector coincides as the correction axis intersection angle; and
determining the profile of the protruding blade of the threaded grinding wheel based on the determined grinding wheel profile point.

9. The gear grinding method according to claim 1, wherein:
the gear is a helical gear; and
the predetermined angle is set to an angle formed by the tooth trace direction on the tooth flank of the gear and a meshing progress direction of a mated gear.

10. The gear grinding method according to claim 1, wherein:
the gear is a spur gear; and
the predetermined angle is set to an inclination angle with respect to the tooth trace direction on the tooth flank of the gear and with respect to a meshing progress direction of a mated gear.

11. A gear grinding device configured to grind a tooth flank of a gear using a threaded grinding wheel, the gear grinding device comprising:
a grinding processing unit configured to grind the tooth flank of the gear by setting an axis intersection angle between a rotation axis of a workpiece and a rotation axis of the threaded grinding wheel to a composite axis intersection angle obtained by combining a reference axis intersection angle (θ1) and a correction axis intersection angle, synchronously rotating the threaded grinding wheel and the workpiece, and relatively moving the threaded grinding wheel in a direction parallel to the rotation axis of the workpiece, wherein
the reference axis intersection angle is an axis intersection angle determined based on a helix angle on a reference circle of the gear and a helix angle on a reference circle of the threaded grinding wheel, and
the correction axis intersection angle is an axis intersection angle for forming a grinding streak in a direction inclined at a predetermined angle with respect to a tooth trace direction on the tooth flank of the gear by the threaded grinding wheel.

12. The gear grinding device according to claim 11, comprising:
a grinding condition determination unit configured to determine grinding conditions including a profile of a protruding blade of the threaded grinding wheel and the composite axis intersection angle; and
the grinding processing unit configured to grind the tooth flank of the gear using the threaded grinding wheel based on the determined grinding conditions.
